(19) United States
(12) Patent Application Publication
(10) Pub. No.: US 2015/0269656 A1
(43) Pub. Date: Sep. 24, 2015

(54) Shopping Cafe

(71) Applicant: Kevin Richard Tamm, Houston, TX (US)

(72) Inventor: Kevin Richard Tamm, Houston, TX (US)

(21) Appl. No.: 14/663,663

(22) Filed: Mar. 20, 2015

Related U.S. Application Data
(60) Provisional application No. 61/969,103, filed on Mar. 22, 2014.

(51) Int. Cl. G06Q 30/06; G06Q 10/08

(52) U.S. Cl. CPC G06Q 30/0639; G06Q 30/0641; G06Q 10/087; G06Q 10/083

(57) ABSTRACT

The present disclosure provides a shopping complex in which consumers can relax and purchase items on a mobile device available for immediate or near immediate delivery.

### PRIORITY

The present application is a U.S. non-provisional patent application claiming priority to U.S. Provisional Patent Application No. 61/969,103 filed Mar. 22, 2014, the entire disclosure of which is hereby expressly incorporated herein by reference in its entirety.

### FIELD

The present disclosure relates generally to a method for shopping and receiving items quickly and without delay caused by the need for delivery. More particularly, the present disclosure relates to a method of relaxed shopping while on a mobile device in a café, restaurant, or similarly relaxing environment with a covert attached storage facility or warehouse housing the items purchased, which can be delivered immediately during and after the shopping experience.

### BACKGROUND

There have existed and currently exist many types of shopping marts, or businesses where consumers can purchase desired items. In the past, communities were centered around general stores in which an assortment of household goods were sold. Such general stores might offer cafés or bars which sell ice cream, soda pop, or similar items. Consumers might eat or drink at such a bar before or after shopping the aisles of the store more generally.

Presently, there is a divide in the retail shopping world. There are physical stores in which consumers search the aisles for goods. Stores can focus on selling specific types of goods, such as “soft” goods or “hard” goods, or stores can generalize in goods sold, such as a department store or a “big box” retailer. On the other hand, there are online retailers providing online shopping experiences through websites and mobile applications or “apps.” Individuals can remain at home or travel to a café, restaurant, or similarly relaxing environment and peruse a cell phone, tablet, laptop computer, or similar mobile device to shop online websites for desired items.

The current problem with physical stores is that the inventory is limited to the physical inventory in stock, and the consumer does not know this limit or what is contained in the daily inventory without wandering around the store, which can take a significant amount of time and effort depending on the size of the physical store. The benefit of physical stores, however, is the obvious fact that the consumer can immediately find items, buy them, and take them home. Additionally, a more recent development in physical stores is the consumer's ability to retrieve items at the store that have been ordered online, but there is still the problem of delivery lag time if the item is not in stock at the physical store location.

Online shopping, quite oppositely, allows a consumer the option to remain completely stationary whether that be at home, in a café, restaurant, or similarly relaxing environment and peruse countless online websites offering essentially any item the consumer could desire. Further, unlike physical stores in which the consumer is not aware of the physical inventory nor able to ascertain inventory availability without physically walking around the store, when the consumer is shopping online, the website presumably only offers items that are available to be shipped, or the website can quickly mark the items that are unavailable. But, the problems with online shopping revolve around cost and time for delivery. Large items are expensive to ship, and longer distances between the consumer and the physical location of the items purchased online increase delivery time.

Therefore, there is a need for a method of purchase which combines the benefits of shopping at a physical store and the benefits of shopping online. Such a method of purchase would allow a user to remain stationary in a relaxing location such as a café, restaurant, or newsstand and shop on a mobile device such as a cell phone, tablet, laptop, or other portable device which is linked to the inventory of an attached physical building only providing the user's device with the available physical inventory for immediate or near immediate pick up or delivery.

### SUMMARY

The present disclosure is directed toward a method of purchase which combines the benefits of shopping at a physical store and the benefits of shopping online. Such a method of purchase would allow a user to remain stationary in a relaxing location such as a café, restaurant, or newsstand and shop on a mobile device such as a cell phone, tablet, laptop, or other portable device which is linked via a network to the inventory of an attached physical building. The network would provide a consumer using a mobile device with the available physical inventory for immediate or near immediate pick up or delivery.

In recent years, the growth of online shopping has proceeded at a quick pace. Certain websites offer for sale nearly every item imaginable, whether it is offered from the company that owns and runs the website, or whether it is offered by third-party sellers who sell on the website and pay the website owning company some share of the profits from the sale. Delivery of items has become quicker as well, as online retailers develop regional warehouses and offer in-store pickup to consumers. However, online purchases have not become immediate and do not offer the consumer the benefits of a physical store.

At the same time the popularity of online shopping has grown, so too has the popularity of “one-stop shopping” or “super” stores in which consumers can find all of the items they need in one retail shopping trip. Large physical store locations now offer groceries, home-goods, hardware, and countless other retail items all at a single location. However, unlike online shopping, it is difficult for consumers, particularly older and disabled consumers, to quickly search and manoeuvre such large physical store locations. Additionally, regardless of the size of a physical store location, it cannot offer the inventory selection that an online site can; thus at the end of a consumer's physical search of a store, the consumer may still be disappointed to find the item he or she desires is not to be found.

While online shopping and one-stop retail shopping have developed, so too has the availability and capability of mobile technology on cell phones, laptops, notebook computers, wrist watch computers, and in vehicles including cars. Such devices and vehicles now make use of remote sensing technologies such as Bluetooth and radio frequency identification (RFID) technologies, as well as near field communication (NFC) between devices.

RFID technology is widely used around the world in passive electronic tag reading applications such as in E-ZPass® systems and long-distance animal tracking technology. RFID technology works with one-way communication, in which a RFID reader interprets information from a passive electronic tag for identification, authentication, or tracking purposes. RFID has also been used to replace bar codes in many applications.

NFC technology is commonly described as a subset of RFID that limits the range of communication to within 10 centimeters or 4 inches. NFC is a less commonly used, developing technology, and it can be used in one-way or two-way communication. In one-way communication, much like RFID technology, NFC tags are read by NFC readers, which operate at different frequencies than standard RFID readers. In two-way NFC communication, neither NFC device is passive. One example of two-way NFC technology would include a smartphone with a collection of digital Black Friday coupons for a local superstore, from which those discounts could be shared with a friend just by tapping phones together. Two-way communication is unique to NFC technology because both instruments are able to read and transmit information, whereas in standard one-way RFID tag technology a reader can only interpret information from a passive electronic tag.

NFC Technology works in the 13.56 MHz radio frequency range and provides greater security for two-way interactions between electronic devices such as contactless transactions, accessing digital content, and connecting electronic devices with a single touch. NFC technology generally supports three modes of operation: (1) reader/writer, (2) peer-to-peer, and (3) card emulation. Reader/writer allows the NFC device, such as a mobile phone, to read NFC Forum-mandated tag types, such as a tag embedded in an NFC smart poster. In peer-to-peer mode, both NFC devices exchange data with each other, or both devices are performing the reading and writing function. In card emulation mode, which is similar to RFID technology, the NFC device appears to an external reader in the same way as a traditional contactless smart card, which enables contactless payments and ticketing by NFC devices without changing the existing infrastructure.

The present disclosure is thus directed at combining the advantages of online shopping, shopping in a physical store location, and the availability of remote or wireless technologies on mobile devices. In one embodiment of the present disclosure, a consumer would go to a physical location of a shopping complex by car, public transportation, or other means of arriving at a place such as biking or walking. The consumer might enter a physical location, might stay outdoors, or might remain in a vehicle or transportation body.

In one embodiment, the above-noted shopping complex would consist of at least a parking lot or similar arrival area for a consumer to arrive either by vehicle or by his or her person, and a separate or attached proximate physical structure containing goods. In one embodiment, the arrival area contains lots or garages for consumers to remain in either a vehicle or otherwise remain stationary upon arrival. The arrival area may be a parking garage or similar enclosed structure. The physical structure containing goods might resemble a warehouse, a store, a vendor's market, or any structure that could contain retail goods. The physical structure might be attached to the arrival area by walking paths, by a drivable bridge, by a walkable bridge, tunnel, or similar travel connection.

In another embodiment, the physical structure containing goods is placed behind, below, or otherwise out of physical sight relative to a consumer relaxation structure or area. In one embodiment, the physical structure containing goods is attached to the consumer relaxation structure. In another embodiment, the physical structure containing goods is in near proximity to the consumer relaxation structure with delivery pathways between the consumer relaxation structure and the physical structure containing goods. The delivery pathways may be drivable or walkable or otherwise traversable by delivery units delivering goods between the consumer relaxation structure and the structure containing physical goods. Delivery units might be delivery persons, automated delivery containers, or manned delivery vehicles.

In yet another embodiment of the present disclosure, the consumer relaxation structure is either an indoor or outdoor area where a consumer can relax generally, relaxing generally being defined as being able to remain stationary and shop on a mobile device without having to walk or otherwise physically move amongst retail goods. Such a consumer relaxation area might be a restaurant, café, newsstand, reading area, park, grotto, or similar tranquil or fun area. From such an area, a consumer could visualize a current retail inventory on a mobile device. A mobile device could be a cell phone, laptop computer, notebook computer, wristwatch computer, or similar device capable of receiving wireless or wired information.

In one embodiment, the current retail inventory is the inventory of physical goods available for immediate or near immediate delivery from the structure containing physical goods through the delivery pathways to the consumer in or near the consumer relaxation area or the arrival area. However, in other embodiments, the consumer could quickly drive or otherwise travel to or through a physical structure containing goods to receive physical goods after purchase on a mobile device. The current retail inventory would be managed in the physical structure containing goods by electronically tracking the goods that come into the physical structure containing goods by company purchase or return, and the goods that leave the physical structure containing goods by either consumer purchase or theft.

The tracking of goods entering and leaving the physical structure could be accomplished by means known in the art such as barcodes, RFID tags, near field communication, Bluetooth, or by any other means that would accomplish maintaining an electronic register of presently available goods in the physical structure. Spreadsheets, inventory database programs, and other means are envisioned to track a physically available inventory.

The number and type of goods entering and leaving the physical structure would be electronically stored on a server, the server being either self-contained at the physical location of the physical structure containing goods, or remotely, such as in cloud software. Such a server would provide to consumers, either by wired or wireless communication, present at or near the consumer relaxation area, a live up-to-date, real-time inventory of the goods contained in the physical structure. The present inventory can be a full real-time inventory of a location storing consumer products, or a partial real-time inventory based on categories and/or user preferences.

In one embodiment, consumers would arrive at the arrival area and plug mobile devices into a computer stand with a wire, the stand being in either wired or wireless communication with the server, and view the presently available inventory of goods at the physical location. In another embodiment, consumers would arrive at the arrival area and be prompted to join a wireless network which would provide the consumer with the availability of the present inventory at the physical location. In yet another embodiment, the consumer would enter a consumer relaxation area and receive on a mobile device either by wireless network, Bluetooth connectivity, RFID communication, or near field communication the present inventory of goods in the physical structure.

In one embodiment, consumers could drive to an enclosed parking garage, and then travel by using an enclosed walkway or people mover to a consumer relaxation area such as a café, restaurant, newsstand, or reading area. The consumer at any point in time between arriving at the arrival area to travelling to or near the consumer relaxation area or physical storage location can be prompted on a mobile device to log onto a wireless network which will provide the consumer with an updated inventory of the physical structure containing goods. Or, the consumer could tap the personal mobile device to a near field communication device or interact with a RFID device to access the updated inventory of goods of the physical structure.

In one embodiment, the consumers will relax in a consumer relaxation area and shop for goods which are presently available for immediate or nearly immediate pick up at, or delivery from, the physical structure containing goods on a personal or provided mobile device such as a cell phone, tablet, wristwatch computer, or laptop computer. Consumers could shop for goods while eating, drinking beverages, reading, playing community games, or being treated by physicians, beauticians, or other service providers. Other consumer relaxation areas might be gyms, child care centers, or waiting rooms for professional services.

The consumer could retrieve the goods either at the consumer relaxation area or the physical structure containing goods either with his or her person or in a vehicle. Alternatively, the consumer ordered goods could be delivered to the consumer relaxation area or the consumer by an employee or by a machine or automated delivery system.

In one embodiment, the goods could be delivered to a consumer or group of consumers while they are seated or otherwise relaxing in a restaurant, café, or reading area. There can be delivery zones or areas where the goods could be brought and the consumer could inspect the goods that were purchased on the mobile device. Such a delivery area can be private or could be public and could be in any close proximity to the consumer relaxation area. Immediate or near immediate delivery or pick up could take merely a few minutes, or could take longer, upwards of an hour or more, depending on the amount, variety, size, complexity, and personalization of the goods ordered by a consumer.

A consumer could ensure the proper delivery of goods by any means known in the art, such as scanning bar codes on goods with a mobile device, scanning QR codes on goods with a mobile device, utilizing RFID technology with a mobile device, or using near-field communication with a mobile device. In one embodiment, proper delivery of goods is aided by table or consumer location numbers. A consumer may take pictures on a mobile device and send them with an order to identify the consumer's location within or proximate to the shopping complex. Alternatively, GPS or NFC on a mobile device or consumer vehicle could be used in accurate goods delivery.

A shopping complex may be comprised of a new arrival area, a new consumer relaxation area, and a new physical structure containing goods, or anyone of these areas could be added to any other pre-existing areas ad hoc. For example, a pre-existing warehouse, underground storage facility, or other physical structure containing goods might have a new consumer relaxation area or arrival area for consumers attached or built in proximity to the pre-existing structure. Or, for example, a pre-existing consumer relaxation area such as a cafe, restaurant, movie theatre, day-care center, or theme-park may have attached to it, or built in near proximity, a warehouse, underground storage structure, or other physical structure containing goods.

In one embodiment of a shopping complex, there are multiple physical structures containing goods wherein the different structures contain different types of goods. The structures containing goods do not need to be attached to the consumer relaxation areas physically, but in proximity to allow immediate or near immediate delivery. In one embodiment, local and proximate physical structures containing goods interact with a server to inform a consumer in a consumer relaxation area where the good is according to GPS and how long it would take for the good to be delivered to the consumer. Goods may be ordered or packaged into consumer order batches, either in carts or other containers, by employees or devices in the physical structures containing goods before delivery to the consumer.

In still another embodiment, the shopping complex could have multiple physically connected or proximate consumer relaxation areas such as spas, restaurants, reading areas, play areas, theme-park areas, gyms, community gathering areas, movie theaters, or any other area where it is contemplated that a consumer could relax or have fun while at the same time purchasing goods that are proximate and available for immediate or near immediate delivery or pick up.

Regarding the available proximate inventory of goods being available on a user's mobile device, this offers the shopping complex the ability to offer daily deals, hourly deals, or other discount or couponing methods nearly instantly. Deals could be based on time of the day, month, year or the number of items purchased, or a consumer membership. The inventory available could be broken out into categories for the consumer on his or her mobile device, such as, for example, hardware, soft goods, electronics, groceries, toiletries, etc. Goods may be sold by the owner of the shopping complex or third parties.

Regarding delivery to the consumer, there could be a human staff at the shopping complex, or the shopping complex and delivery to the consumer could be almost completely mechanized, wherein the goods could be scanned into the physical structure containing goods when they arrive, scanned out of the physical structure containing goods when they are purchased by the consumer and delivered, and the consumer can scan to double check that he or she received the correct item. The consumer could choose the delivery location on the mobile device such as present location, available through GPS or Bluetooth on the mobile device, a consumer relaxation area, the arrival area, at a vehicle, or the consumer could choose to pick up the items.

Also, a consumer could take a picture of a delivery area to identify through the mobile device the specific location where pickup or delivery should occur, such as a numbered table or parking space. With consumer and employee interaction with goods reduced before purchase, it is envisioned that theft may decrease, and the goods tracking system in one embodiment provides statistics to a user on a display about reduction in theft.

Based on the preceding disclosure, the benefits of the system and method herein are many. First, a consumer can relax and purchase goods for immediate or near immediate delivery while on a mobile device without having to walk or otherwise traverse a store to determine available inventory. Additionally, unlike online shopping, there would be essentially no wait time for delivery and less risk of damaged or lost goods in transit. Further, the benefit to the owner or operator of the shopping complex is less overhead regarding stocking shelves designed to be aesthetically pleasing, as the goods are generally kept out of sight of the consumer. Additionally, without the consumer wandering a crowded store with aisles, there is less opportunity for theft and shoplifting.

Therefore, the present disclosure presents a shopping complex comprising: an arrival area for consumers, at least one consumer relaxation area, and at least one physical structure containing goods, wherein consumers interact with a mobile device which connects with a network accessible proximate to the shopping complex, wherein the network provides to the consumer a current inventory of goods in the at least one physical structure, and wherein the goods are presently available for purchase and immediate or near immediate delivery to, or pickup by, the consumer at a consumer-specified delivery location.

In other embodiments, the mobile device connects wirelessly with the network, and the network is connected to a server which tracks the current inventory in the physical structure containing goods by maintaining a balance of goods entering the at least one physical structure and exiting the at least one physical structure.

In other embodiments, the server maintains a balance of goods entering and exiting the physical structure by electronic scanning means. Still in other embodiments, the electronic scanning means is selected from the group consisting of: bar codes, RFID technology, near field communication, and Bluetooth technology. In yet still other embodiments, the consumer relaxation area is selected from the group consisting of: restaurants, cafes, spas, gyms, theme parks, reading areas, parks, newsstands, desert areas, child care areas, community meeting areas, and community gaming areas.

And in other embodiments, the immediate or near immediate delivery takes place in an area selected from the group consisting of: an arrival area, a consumer relaxation area, and an area in a physical structure containing goods.

Also provided by the present disclosure is a method for selling goods comprising the steps of: storing goods in at least one physical structure within a shopping complex; providing consumers an arrival area at which to arrive at the shopping complex; tracking current inventory going into and out of the physical structure containing goods with electronic scanning means and a server; and providing to proximate consumers via a network connected to the server a present inventory of goods available for immediate or near immediate purchase and delivery to the consumer at the shopping complex, wherein the present inventory of goods is viewable on a mobile device. In other embodiments the method further comprises the step of providing the consumer with a consumer relaxation area.

In still other embodiments, the consumer relaxation area is selected from the group consisting of: restaurants, cafes, spas, gyms, theme-parks, reading areas, parks, newsstands, desert areas, child care areas, community meeting areas, and community gaming areas. In still other embodiments, the network is a wireless network. And in still other embodiments, the electronic scanning means is selected from the group consisting of: bar codes, RFID technology, near field communication, and blue tooth technology.

In another embodiment, the immediate or near immediate delivery takes place in the one of the areas selected from the group consisting of: an arrival area, a consumer relaxation area, and a physical structure containing goods.

The disclosure also provides a method for selling goods comprising the steps of: storing goods in at least one physical structure within a shopping complex; providing consumers an arrival area at which to arrive at the shopping complex; tracking current inventory going into and out of the physical structure containing goods with electronic scanning means and a server; providing to proximate consumers via a network connected to the server a present inventory of goods available for immediate or near immediate purchase and delivery to the consumer at the shopping complex, wherein the present inventory of goods is viewable on a mobile device; delivering to consumers goods ordered by the consumer on a mobile device from the physical structure at a delivery location specified by the consumer via a mobile device within, or proximate to, the shopping complex.

In other embodiments, the delivery location specified by the consumer is specified via a picture taken on a mobile device. Still in other embodiments, certain goods within the physical structure are offered at a deal to the consumer when purchased under a specified condition, the specified condition selected from the group consisting of: time of day, season of the year, holidays, type of mobile device, consumer membership, and buying location.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a diagram which illustrates an exemplary shopping complex for shopping on mobile devices and receiving immediate or near immediate delivery of goods.

FIG. 2 is also a diagram which illustrates an exemplary shopping complex for shopping on mobile devices and receiving immediate or near immediate delivery of goods.

FIG. 3 illustrates an exemplary consumer relaxation area with a consumer shopping on a mobile device for receiving immediate or near immediate delivery of goods.

FIG. 4 illustrates an exemplary user interface for a consumer shopping on a mobile device for receiving immediate or near immediate delivery of goods.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF THE DRAWINGS

The embodiments disclosed herein are not intended to be exhaustive or limit the disclosure to the precise form disclosed in the following detailed description. Rather, the embodiments are chosen and described so that others skilled in the art may utilize their teachings.

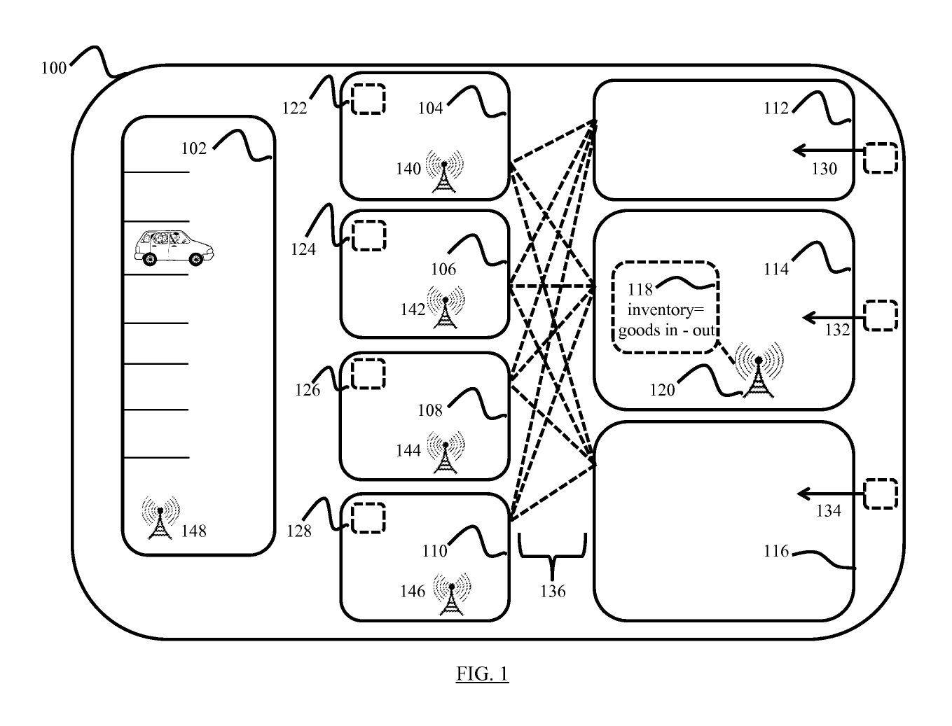

Referring first to FIG. 1, an exemplary shopping complex 100 for shopping on mobile devices and receiving immediate or near immediate delivery of goods is shown. The shopping complex 100 may be quite large in size or quite small in size depending upon the availability of land, for instance in a crowded downtown or in a spacious rural area. The shopping complex 100 may include arrival areas 102 such as parking lots or parking garages, or may include arrival areas as simple as a drop off for a bus, train, or bikes, or may simply be an area where people walk to and arrive at, from home or work.

The shopping complex 100 may contain consumer relaxation areas 104, 106, 108, and 110, which may be connected or separate, and might offer similar or different services. In one embodiment a restaurant, café, spa, and gym would be provided side by side. Additionally, the shopping complex 100 may contain physical structures containing goods 112, 114, and 116. More or less buildings of any size are contemplated for physical structures containing goods. Such structures may be permanent buildings above-ground such as warehouses, buildings below ground such as basements, or may be mobile structures such as the trailers of tractor trailers. Such structures may be connected either above or below ground and may allow for the transfer of people, goods, and vehicles between the buildings.

The physical structures 112, 114, 116 receive goods 130, 132, and 134 which may be mixed goods or goods separated by type, price, physical structure, department, or any other known retail sorting method. The goods 130, 132, 134 might arrive at the physical structures by train, truck, or other delivery mechanism. When the goods 130, 132, 134 enter the physical structures 112, 114, 116 they are scanned by one of known methods such as, for example, bar code, RFID, QR scanner, or near field communication into a presently available for sale inventory. A Server 118, communicable with one or more processors and non-transitory computer readable medium, uses software to track inventory and tracks the goods 130, 132, 134 that enter the physical structures 112, 114, 116 and the inventory that leaves the physical structures by delivery paths 136. The server 118 can include memory and computer access stations. The server 118 may be either at the shopping complex 100 or the server 118 may be at a remote location, or the inventory data can be stored in cloud computing. The server 118 can be in either wired or wireless, or both, communication with a wireless transmitter 120 which transmits a wireless network which can be secured by passwords or passcodes, or unsecured.

The delivery paths 136 from the physical structures 112, 114, 116 allow for varied and convenient delivery between any physical structure containing goods and any consumer relaxation area 104, 106, 108, 110 or arrival area 102. Further, not shown, is the ability for the delivery of goods from the physical structures 112, 114, 116 to the arrival area 102. Wireless transmitters 140, 142, 144, 146, and 148 allow consumers to wirelessly access the wireless network 120 emanating from wireless transmitter 120.

Consumer connection devices 122, 124, 126, and 128 allow consumers to either connect via usb or other wired connection to the network at the consumer relaxation areas, or allow via RFID, near field communication, or other wireless means consumers to access special inventories, deals, coupons, or other items based on special circumstances such as time of the day, season, month or the type of past goods they have purchased at the shopping complex.

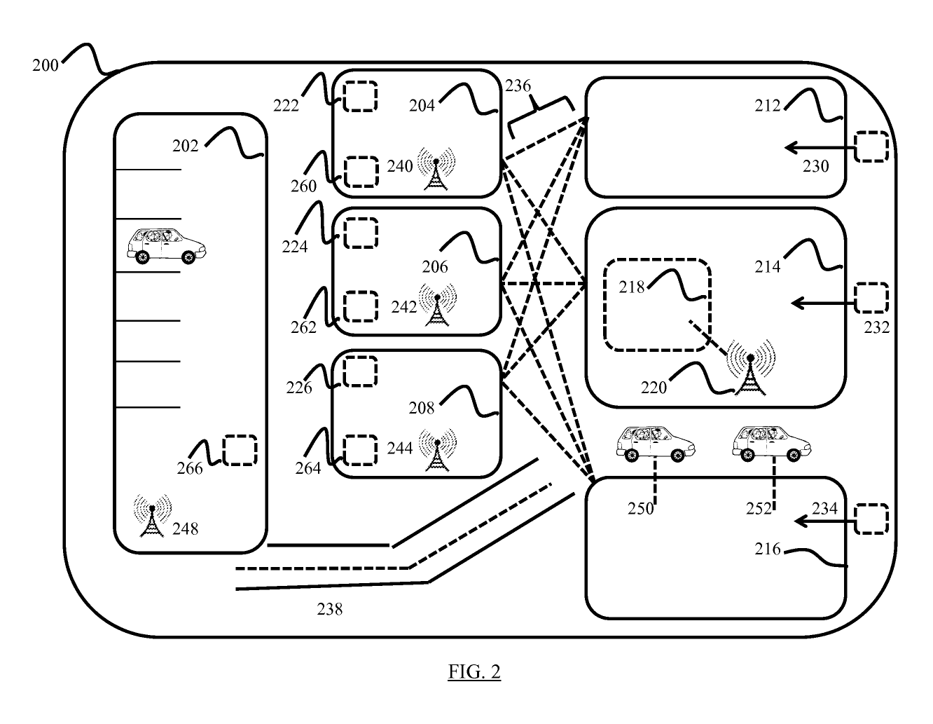

Referring now to FIG. 2, an exemplary shopping complex 200 for shopping on mobile devices and receiving immediate or near immediate delivery of goods is provided. The shopping complex 200 is similar in design to shopping complex 100 of FIG. 1; however, a transport means 238 is shown whereby consumers could purchase goods 230, 232, 234 wirelessly on mobile devices and pick up the goods 230, 232, 234 without exiting a vehicle or disengaging from a transportation means such as a bike or automobile. Such pick up could be done at locations 250 and 252, and consumer goods purchases could arrive at the car, or consumers could enter physical structure 216 to inspect the goods before pickup. Additionally shown in FIG. 2 are consumer pick up and inspection areas 260, 262, and 264. These are examples of areas where batches of purchased goods might be delivered for consumer inspection by mobile device scan. Consumers could identify a preferred delivery location by taking a picture and sending it with the order to the shopping complex.

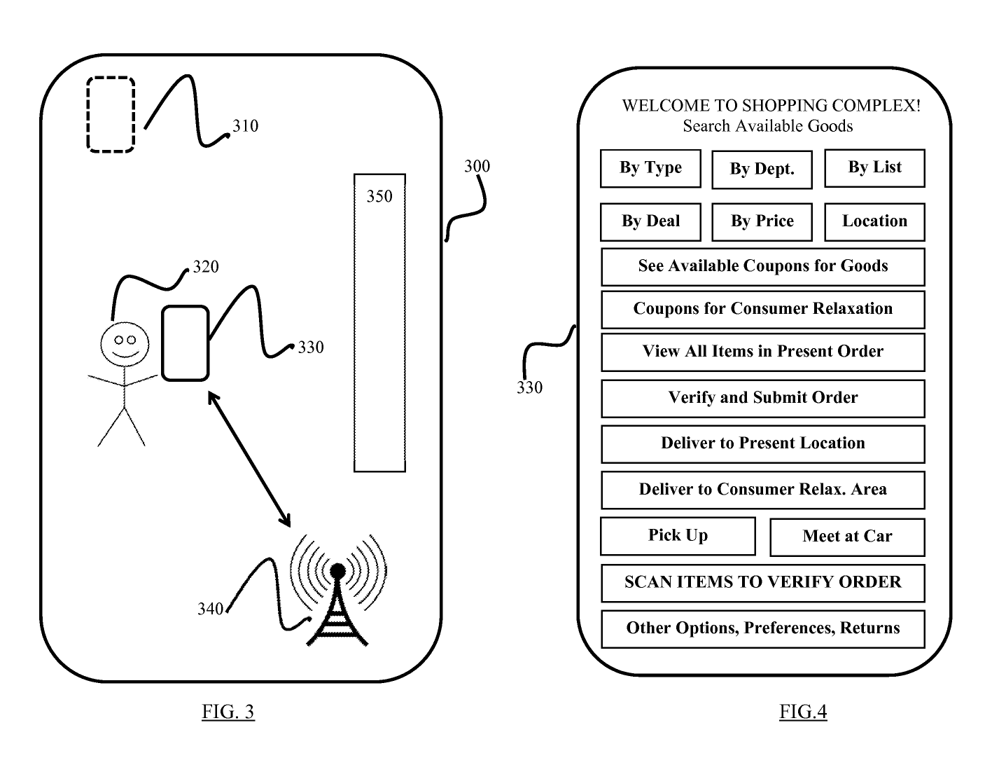

Referring now to FIG. 3, an exemplary consumer relaxation area 300 is shown. A consumer 320 engages a mobile device 330 which engages at least one shopping complex wireless network emanating from wireless transmitter 340. The mobile device 330 may belong to the consumer 320, or may be provided to the consumer 320 by the consumer relaxation area. In the exemplary embodiment, the consumer 320 might buy coffee at coffee bar 350, also with a wireless device and through at least one wireless network of the shopping complex emanating from wireless transmitter 340. Additionally, the consumer could connect with a usb or other wired connection, or connect with a wireless connection, near field communication, Bluetooth, or RFID technology with the consumer connection device 310. In this way, special deals, coupons, or inventories could be accessed and specifically associated with the consumer and his or her buying habits.

Referring now to FIG. 4, one embodiment of options presented to a consumer on a mobile device screen is shown. Such options may be presented through a mobile device application, or “app,” or such a display may be presented through a web page upon connecting with at least one wireless network of the shopping complex. Other available options not shown are within the scope of this disclosure such as choosing a specific delivery time, choosing delivery based on a consumer dinner schedule, a workout schedule, a spa schedule, or designating routine times for repeated consumer pickups or deliveries.

As shown in FIG. 4, the consumer can browse goods available for immediate or near-immediate delivery (or pick up) by type, department, list, deal, price, and location. Other selections could be included, such as seasonal, regional, time of day, goods, services, favorites, etc. Coupons can be viewed, as well as goods in a present order. Each item may be bought separately as a separate order, or items may be purchased together in a group or “shopping basket.” A selection to “Deliver to Present Location” is shown in FIG. 4, and as discussed above, a consumer may take a picture of a location, number, and/or other landmark within or near a structure such as shopping complex 100 to have the good or goods delivered. Alternatively, certain points within shopping complex 100 may have bar codes or other scannable codes to be scanned by a mobile device to set the delivery location for a good or goods.

Alternatively, as shown in FIG. 4, a user can select to pick up goods or meet at a car. As discussed above, the items, once delivered or picked up, can be scanned to verify that the correct items have been delivered to the consumer.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a,” “an,” and “the” include plural referents, unless the context clearly dictates otherwise.

Optional or optionally means that the subsequently described event or circumstances can or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made herein.

As used herein and in the appended claims, the words “comprise,” “has,” and “include” and all grammatical variations thereof are each intended to have an open, non-limiting meaning that does not exclude additional elements or steps.

As used herein, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present invention.

In the various embodiments of the invention described herein, a person having ordinary skill in the art will recognize that various types of memory are readable by a computer, such as the memory described herein in reference to the various computers and servers, e.g., computer, computer server, web server, or other computers with embodiments of the present invention.

Examples of computer-readable medium can include but are not limited to: one or more nonvolatile, hard-coded type media, such as read only memories (ROMs), CD-ROMs, and DVD-ROMs, or erasable, electrically programmable read only memories (EEPROMs); recordable type media, such as floppy disks, hard disk drives, CD-R/RWs, DVD-RAMs, DVD-R/RWs, DVD+R/RWs, flash drives, memory sticks, and other newer types of memories; and transmission type media such as digital and analog communication links. For example, such media can include operating instructions, as well as instructions related to the systems and the method steps described above and can operate on a computer. It will be understood by those skilled in the art that such media can be at other locations instead of, or in addition to, the locations described to store computer program products, e.g., including software thereon. It will be understood by those skilled in the art that the various software modules or electronic components described above can be implemented and maintained by electronic hardware, software, or a combination of the two, and that such embodiments are contemplated by embodiments of the present invention.

In the drawings and specification, there have been disclosed embodiments of methods, systems, and non-transitory computer-readable medium having computer programs stored therein of the present invention, and although specific terms are employed, the terms are used in a descriptive sense only and not for purposes of limitation. The embodiments of methods, systems, and non-transitory computer-readable medium having computer programs stored therein of the present invention have been described in considerable detail with specific reference to these illustrated embodiments. It will be apparent, however, that various modifications and changes can be made within the spirit and scope of the embodiments of methods, systems, and non-transitory computer-readable medium having computer programs stored therein of the present invention as described in the foregoing specification, and such modifications and changes are to be considered equivalents and part of this disclosure.

What is claimed is:

1. A system for shopping on an electronic device for consumer products available for near immediate acquisition, the system comprising:
an arrival area for consumers, the arrival area proximate to a shopping complex;
at least one consumer relaxation area, where the at least one consumer relaxation area is proximate the arrival area;
at least one physical structure containing consumer products for sale, where the at least one physical structure is proximate the consumer relaxation area; and
an electronic user interface, where the electronic user interface is displayed on a mobile device communicable with a local network accessible proximate to the consumer relaxation area, the electronic user interface operable to,
display presently available consumer products to a consumer according to selectable categories, where the consumer products are available for immediate purchase and near immediate acquisition by the consumer from the at least one physical structure,
allow the consumer to identify by the electronic device a proximate location to acquire the consumer products, and
allow the consumer to verify by the electronic device that correct consumer products have been acquired.

2. The system of claim 1, wherein the mobile device connects wirelessly with the local network, and
wherein the local network is connected to a server which tracks a current inventory in the at least one physical structure containing consumer products by maintaining a balance of the consumer products entering the at least one physical structure and exiting the at least one physical structure.

3. The system of claim 2, wherein the server maintains a balance of consumer products entering and exiting the physical structure by electronic scanning means.

4. The system of claim 3, wherein the electronic scanning means is selected from the group consisting of: bar codes, RFID technology, near field communication, and Bluetooth technology.

5. The system of claim 1, wherein the consumer relaxation area is selected from the group consisting of: restaurants, cafes, spas, gyms, theme parks, reading areas, parks, newsstands, desert areas, child care areas, community meeting areas, movie theaters, and community gaming areas.

6. The system of claim 1, wherein the immediate or near immediate delivery takes place in an area selected from the group consisting of: the arrival area, the consumer relaxation area, and an area in the at least one physical structure containing consumer products.

7. The system of claim 1, wherein the electronic user interface is further operable to allow the consumer to identify by the electronic device a proximate location to acquire the goods and services by a location identification selected from the group consisting of: a photograph of a location, GPS coordinates of a current location, Bluetooth identification of a location, electronic scanning of a location, and mixtures thereof.

8. The system of claim 1, where the near immediate acquisition by the consumer from the at least one physical structure is between about five minutes and about one hour.

9. The system of claim 1, where the near immediate acquisition by the consumer from the at least one physical structure is between about twenty minutes and about thirty minutes.

10. The system of claim 1, where presently available consumer products for display are consumer products available for purchase in real-time responsive to consumer products in less consumer products out of the at least one physical structure containing consumer products for sale.

11. A method for shopping on an electronic mobile device for consumer products available for near immediate acquisition, the method comprising the steps of:
allowing arrival of consumers at an arrival area proximate to a shopping complex;
providing at least one consumer relaxation area, where the at least one consumer relaxation area is proximate the arrival area;
operating at least one physical structure containing consumer products for sale, where the at least one physical structure is proximate the consumer relaxation area;
providing an electronic user interface, where the electronic user interface is displayed on a mobile device communicable with a local network accessible proximate to the consumer relaxation area;
displaying by the electronic user interface presently available consumer products to a consumer according to selectable categories, where the consumer products are available for immediate purchase and near immediate acquisition by the consumer from the at least one physical structure;
allowing the consumer to identify by the electronic device a proximate location to acquire the consumer products;
delivering to the consumer one or more purchased consumer products;
allowing the consumer to verify by the electronic device that correct consumer products have been acquired.

12. The method of claim 11, further comprising the step of allowing the consumer to return one or more consumer products to the at least one physical structure containing consumer products.

13. The method of claim 11, wherein the mobile device connects wirelessly with the local network, and
wherein the local network is connected to a server which tracks a current inventory in the at least one physical structure containing consumer products by maintaining a balance of the consumer products entering the at least one physical structure and exiting the at least one physical structure.

14. The method of claim 13, wherein the server maintains a balance of consumer products entering and exiting the physical structure by electronic scanning means.

15. The method of claim 14, wherein the electronic scanning means is selected from the group consisting of: bar codes, RFID technology, near field communication, and Bluetooth technology.

16. The method of claim 11, wherein the consumer relaxation area is selected from the group consisting of: restaurants, cafes, spas, gyms, theme parks, reading areas, parks, newsstands, desert areas, child care areas, community meeting areas, movie theaters, and community gaming areas.

17. The method of claim 11, wherein the immediate or near immediate delivery takes place in an area selected from the group consisting of: the arrival area, the consumer relaxation area, and an area in the at least one physical structure containing consumer products.

18. The method of claim 11, wherein the step of allowing the consumer to identify by the electronic device a proximate location to acquire the consumer products comprises a location identification selected from the group consisting of: a photograph of a location, GPS coordinates of a current location, Bluetooth identification of a location, electronic scanning of a location, and mixtures thereof.

19. The method of claim 11, where the step of delivering to the consumer one or more purchased consumer products takes between about five minutes and about one hour.

20. The method of claim 11, where the step of delivering to the consumer one or more purchased consumer products takes between about twenty minutes and about thirty minutes.
